(19) United States
(12) Patent Application Publication
(10) Pub. No.: US 2025/0121364 A1
(43) Pub. Date: Apr. 17, 2025

(54) METHODS OF MAKING ZEOLITE BETA MATERIALS

(71) Applicants: Saudi Arabian Oil Company, Dhahran (SA); King Abdullah University of Science and Technology, Thuwal (SA)

(72) Inventors: Rajesh Kumar Parsapur, Thuwal (SA); Robert Peter Hodgkins, Dhahran (SA); Omer Refa Koseoglu, Dhahran (SA); Kuo-Wei Huang, Thuwal (SA); Magnus Rueping, Thuwal (SA); Anissa Bendjeriou Sedjerari, Thuwal (SA)

(73) Assignees: Saudi Arabian Oil Company, Dhahran (SA); King Abdullah University of Science and Technology, Thuwal (SA)

(21) Appl. No.: 18/485,844

(22) Filed: Oct. 12, 2023

(51) Int. Cl. B01J 29/70; B01J 35/04; B01J 35/10; B01J 37/03; B01J 37/06; B01J 37/08

(52) U.S. Cl. CPC B01J 29/7007; B01J 35/56; B01J 35/695; B01J 37/038; B01J 37/06; B01J 37/08

(57) ABSTRACT

According to one or more embodiments, a zeolite beta material may be made by a method that may include adding a parent zeolite beta in a basic solution to form a basic zeolite beta suspension, adding water to the basic zeolite beta suspension to form a dilute basic zeolite beta suspension, hydrothermally treating the dilute basic zeolite beta suspension to form a hydrothermally treated mixture, and separating from the hydrothermally treated mixture a solid zeolite beta material consisting essentially of polymorph-A and polymorph-B. The molar ratio of polymorph-A to polymorph-B of the solid zeolite beta material may be greater than molar ratio of polymorph-A to polymorph-B of the parent zeolite beta.

### FIELD

The embodiments described herein generally relate to porous materials and, more particularly, to zeolites.

### BACKGROUND

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as ZSM-5 or beta.

Zeolite containing catalysts and adsorbents have widespread uses in many diverse industries. Exemplary industries include the petrochemical industry in refinery, gas separation, and carbon dioxide separation and capture processes. In the petroleum industry, for example, zeolite containing catalysts may be included in processes such as fluid catalytic cracking (FCC) and hydrocracking to catalyze reactions such as hydrogenation, dehydrogenation, isomerization, alkylation, and cracking, for example. Zeolite containing adsorbents may be utilized in the separation of paraffins or aromatic isomers, and in drying processes to remove water and other impurities from hydrocarbon streams.

### SUMMARY

Embodiments of the present disclosure are directed to zeolite materials and methods for making zeolite beta materials having a molar ratio of polymorph-A to polymorph-B that is greater than the molar ratio of polymorph-A to polymorph-B of the starting zeolite beta material (referred to sometimes herein as “polymorph-A enriched” zeolite beta materials). Conventional zeolite beta materials typically include an intergrowth of chiral polymorph-A and achiral polymorph-B. A zeolite beta material comprising a greater mole percentage of polymorph-A to polymorph-B may have desirable chemical properties because of the chirality of polymorph-A. For example, a zeolite beta material comprising a greater mole percentage of polymorph-A to polymorph-B may have desirable shape selectivity and enantioselectivity when utilized as a catalyst.

Conventional methods used to make zeolite beta materials that are polymorph-A enriched may be relatively difficult or/and expensive to perform, for example, utilizing complex procedures and reagents during the synthesis of polymorph-A enriched zeolite beta materials. For example, conventional methods used to make zeolite beta materials that are polymorph-A enriched may require the use of chiral reagents, such as organic structure-directing agents, or may utilize highly corrosive compounds such as HF. Accordingly, new methods of making zeolite beta materials that are polymorph-A enriched are desired.

The methods of making zeolite beta materials that are polymorph-A enriched of the present disclosure may meet this need, according to various embodiments disclosed herein. For example, some methods of the present disclosure may not require the use of complex reagents and procedures. Rather, according to one or more embodiments, the methods of the present disclosure may produce zeolite beta materials that are polymorph-A enriched by adding a parent zeolite beta to a basic solution before diluting the suspension. The dilute suspension may then be hydrothermally treated to form a solid zeolite beta material, wherein the molar ratio of polymorph-A to polymorph-B of the solid zeolite beta material is greater than a molar ratio of polymorph-A to polymorph-B of the parent zeolite beta. Some such processes may avoid the use of organic structure-directing agents and/or highly corrosive compounds.

According to one or more embodiments, a zeolite beta material may be made by a method that may comprise adding a parent zeolite beta in a basic suspension to form a basic zeolite beta suspension, adding water to the basic zeolite beta suspension to form a dilute basic zeolite beta suspension, hydrothermally treating the dilute basic zeolite beta suspension to form a hydrothermally treated mixture, and separating from the hydrothermally treated mixture a solid zeolite beta material consisting essentially of polymorph-A and polymorph-B. The molar ratio of polymorph-A to polymorph-B of the solid zeolite beta material may be greater than molar ratio of polymorph-A to polymorph-B of the parent zeolite beta.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts the structures of various polymorphs of zeolite beta in a 2-dimensional plane, according to one or more embodiments described herein;

FIG. 2 depicts X-ray diffraction patterns of simulated zeolite beta materials having varying ratios of polymorph-A to polymorph-B, according to one or more embodiments described herein;

FIG. 3 depicts X-ray diffraction patterns of simulated zeolite beta materials and zeolite beta materials made using a method according to one or more embodiments described herein;

FIG. 4 depicts X-ray diffraction patterns of a simulated zeolite beta material and zeolite beta materials made using methods according to one or more embodiments described herein;

FIG. 5 depicts X-ray diffraction patterns of zeolite beta materials made using methods according to one or more embodiments described herein;

FIG. 6 depicts a transmission electron micrograph of zeolite beta materials made using methods according to one or more embodiments described herein.

Reference will now be made in greater detail to various embodiments, some embodiments of which are illustrated in the accompanying drawings.

### DETAILED DESCRIPTION

One or more embodiments presently described herein are directed to methods of making zeolite beta materials that are polymorph-A enriched. As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure, as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

Generally, zeolites may be characterized by a microporous framework type, which defines their microporous structure. Framework types are described in, for instance, “Atlas of Zeolite Framework Types” by Christian Baerlocher et al., Sixth Revised Edition, published by Elsevier, 2007, the teachings of which are incorporated by reference herein. The structure of Zeolite beta can generally be described as the intergrowth of two or more distinct, but closely related framework types, or “polymorphs,” each made up of three-dimensional pore systems comprising 12-membered rings. According to embodiments, zeolite beta may generally be an intergrowth of chiral polymorph A(*BEA) and achiral polymorphs B and C.

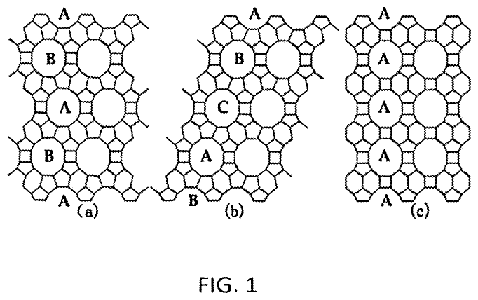

As shown in FIG. 1, the structure of zeolite beta can be understood to be many layers of a base building unit, where the individual polymorphs arise depending on the shifting of a layer relative to adjacent layers (as described in Tong et al., CrystEngComm, 2016, 18, 1782-1789). In FIG. 1, polymorph-A is depicted in structure (a), polymorph-B is depicted in structure (b), and polymorph-c is depicted in structure (c). In embodiments, the zeolite beta materials described herein may comprise an intergrowth of polymorph-A and polymorph-B. Polymorph-A is a three-dimensional pore system with pore diameters of 0.56 nm×0.56 nm and 0.66 nm×0.67 nm. The unit cell parameters for polymorph-A are a=12.6614 Å, b=12.6614 Å, c=26.4061 Å, α=90.0000°, β=90.0000°, γ=90.0000°, and a volume of 4233.2 Å³. The pores are arranged along the c-axis of the unit cell as either a right-handed helix or a left-handed helix. Accordingly, polymorph-A has two chiral, enantiomeric forms. On the other hand, “polymorph-B,” describes a three-dimensional pore system with unit cell parameters a=17.8965 Å, b=17.9200 Å, c=14.3282 Å, α=90.0000°, β=114.8030°, γ=90.0000°, and a volume of 4171.3 Å³. The pores are organized in an alternating right-handed and left-handed fashion, resulting in an overall achiral pore arrangement.

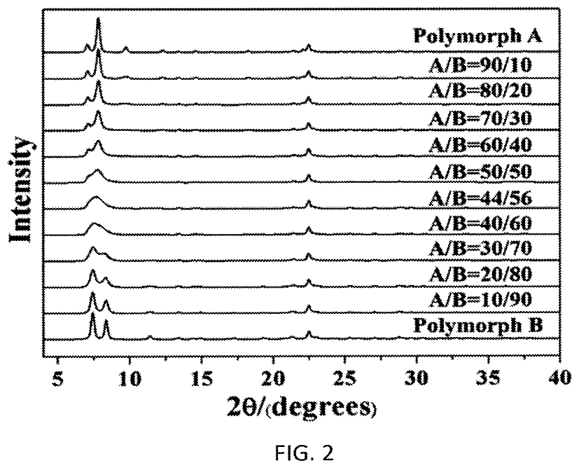

Generally, in any given zeolite beta that includes polymorph-A and polymorph-B, a ratio of polymorph-A to polymorph-B can be determined. As would be understood by those skilled in the art, the ratio of polymorph-A to polymorph-B in a target zeolite beta sample can be determined by comparing an x-ray diffraction pattern of the target zeolite beta with a simulated x-ray diffraction pattern of zeolite beta samples with differing ratios of polymorph A to Polymorph B. For example, FIG. 2 shows simulated x-ray diffraction patterns of zeolite beta at different ratios of polymorph-A to polymorph-B. Simulated x-ray diffraction patterns, such as those in FIG. 2 can be generated utilizing the DIFFaX program on the basis of a general recursion algorithm as described by Lu et al., “Chiral Zeolite Beta: Structure, Synthesis, and Application,” Inorg. Chem. Front., 2019, 6, 1938, and Treacy et al., “A general recursion method for calculating diffracted intensities from crystals containing planar faults”, Proc. R. Soc. London, Ser. A, 1991, 433, 499, the disclosures of which are incorporated herein by reference in their entireties. Unless described otherwise herein, measurements of the ratio of polymorph-A to polymorph-B are determined herein based on the procedures outlined in Lu et al. and based on the data of FIG. 2. Determination of the ratio of polymorph-A to polymorph-B may be approximate in some circumstances, but it is evident, based on the procedures described herein, whether a particular zeolite has greater than molar ratio of polymorph-A to polymorph-B than another particular zeolite. That is, simple comparison of the x-ray diffraction pattern of a sample zeolite beta with the diffraction patterns of FIG. 2 can be utilized to determine the approximate ratio of polymorph-A to polymorph-B.

According to one or more embodiments described herein, the solid zeolite beta material may consisting essentially of, or consist of, the combination of polymorph-A and polymorph-B. As described herein, consisting essentially of refers to those materials being present in an amount no less than about 99.5 wt. % of the total composition.

In some conventional examples, zeolite beta typically crystallizes as an intergrowth of racemic polymorph-A and achiral polymorph-B, with an overall mole ratio of polymorph-B to polymorph-A of about 1.3:1. Thus, many conventional zeolite beta materials typically lack chirality, such as the zeolites that may be utilized as parent zeolites in the presently described processes. There is an interest in preparing zeolite beta materials that are enriched in polymorph-A, meaning that the materials contain a greater molar ratio of polymorph-A to polymorph-B than the molar ratio of the starting zeolite material.

Now described are methods of making zeolite beta materials according to one or more embodiments of the present disclosure. In one or more embodiments, a basic zeolite beta suspension may be prepared by adding a “parent zeolite beta” with heating, agitating, or both to a basic solution. Water may be added to the basic zeolite beta suspension with heating, agitating, or both to form a dilute basic zeolite beta suspension. The dilute basic zeolite beta suspension may then be hydrothermally treated to form a hydrothermally treated mixture. Finally, a solid zeolite beta material may be separated from the hydrothermally treated mixture, a molar ratio of polymorph-A to polymorph-B of the solid zeolite beta material is greater than a molar ratio of polymorph-A to polymorph-B of the parent zeolite beta.

According to embodiments of the method disclosed herein, the basic solution may comprise, comprise at least 95 wt. %, comprise at least 99 wt. %, or consist of one or more basic compounds dissolved in a solvent. In one or more embodiments, the basic solution may have a pH of greater than or equal to 7, such as, for example greater than or equal to 8, greater than or equal to 9, greater than or equal to 10, greater than or equal to 11, greater than or equal to 12, greater than or equal to 13, or even greater than or equal to 14. In one or more embodiments, the basic solution may have a pH of from 7 to 14, such as for example, from 7 to 8, from 8 to 9, from 9 to 10, from 10 to 11, from 11 to 12, from 12 to 13, from 13 to 14, or any combination of one or more of these ranges.

In one or more embodiments, the basic solution may comprise urea dissolved in water. In such embodiments, the mass ratio of urea to water may be from 1:10 to 1:60, such as from 1:10 to 1:15, from 1:15 to 1:20, from 1:20 to 1:25, from 1:25 to 1:30, from 1:30 to 1:35, from 1:35 to 1:40, from 1:40 to 1:45, from 1:45 to 1:50, from 1:50 to 1:55, from 1:55 to 1:60, or any combination of one or more of these ranges. Without being bound by theory it is believed that a mass ratio of urea to water of less than 1:10 may cause increased desilication and a decrease in the yield of the final zeolite material when compared to a mass ratio of urea to water from 1:10 to 1:60. However, it is also believed that a mass ratio of urea to water of greater than 1:60 may produce a solution with a lower pH which may prevent complete dissolution of the parent zeolite beta. It is also believed that during hydrothermal treatment urea may react to form ammonium hydroxide and the pH may be increased relatively slowly to a maximum pH as a function of time. This may be beneficial to the process, because it may allow better control of the pH of the solution and suspension after zeolite addition as compared to adding an amount of another alkaline reagent, such as ammonium hydroxide, in the initial suspension to achieve the final maximum pH.

As described hereinabove, in one or more embodiments, a parent zeolite beta may be added to the basic solution and may be dissolved into the basic solution during hydrothermal treatment. The basic suspension may be agitated while the parent zeolite beta is being added to the basic suspension or after the parent zeolite has been added to the basic solution. The basic suspension may be agitated by, for example, mixing, stirring, or shaking the basic suspension. In one or more embodiments, the parent zeolite beta may comprise, consist essentially of, or consist of polymorph-A and polymorph-B. The parent zeolite beta may comprise a greater mole percentage of polymorph-B than polymorph-A. In some embodiments, the parent zeolite beta may comprise equal mole percentages of polymorph-B and polymorph-A. A silica to alumina mole ratio in the parent zeolite beta may be from 10:1 to 10,000:1, such as from 10:1 to 20:1, from 20:1 to 50:1, from 50:1 to 100:1, from 100:1 to 500:1, from 500:1 to 1000:1, from 1000:1 to 5000:1, from 5000:1 to 10,000:1 or any combination of one or more of these ranges. The parent zeolite beta may be a synthesized or may be a commercially available zeolite beta such as those available from Zeolyst International or Clariant.

In one or more embodiments, after adding the parent zeolite beta to the basic solution, the basic zeolite beta suspension may be agitated at a temperature of from 20° C. to 40° C. for a duration of from 1 minute to 12 hours. The basic zeolite beta suspension may be agitated at a temperature of from 20° C. to 25° C., from 25° C. to 30° C., from 30° C. to 35° C., from 35° C. to 40° C., or any combination of one or more of these ranges. The basic zeolite beta suspension may be agitated for from 1 minute to 1 hour, from 1 hour to 2 hours, from 2 hours to 3 hours, from 3 hours to 4 hours, from 4 hours to 5 hours, from 5 hours to 6 hours, from 6 hours to 7 hours, from 7 hours to 8 hours, from 8 hours to 9 hours, from 9 hours to 10 hours, from 10 hours to 11 hours, from 11 hours to 12 hours, or any combination of one or more of these ranges.

In one or more embodiments, the basic zeolite beta suspension may comprise a mass ratio of urea to zeolite beta of from 0.8:1 to 1.2:1, such as from 0.8:1 to 0.9:1, from 0.9:1 to 1:1, from 1:1 to 1.1:1, from 1.1:1 to 1.2:1, or from any combination of one or more of these ranges. Without being bound by theory it is believed that a mass ratio of urea to zeolite beta of less than 0.8:1 may cause increased desilication and a decrease in the yield of the final zeolite material when compared to a mass ratio of urea to zeolite beta of greater than or equal to 0.8:1. However, it is also believed that a mass ratio of urea to zeolite beta of greater than 1.2:1 may produce a suspension with a lower pH which may prevent complete dissolution of the zeolite beta.

In one or more embodiments, a volume of water may be added to the basic zeolite beta suspension to form a dilute basic zeolite beta suspension. In embodiments, the dilute basic zeolite beta suspension may comprise a mass ratio of zeolite beta to water of from 1:15 to 1:100, such as from 1:15 to 1:20, from 1:20 to 1:25, from 1:25 to 1:30, from 1:30 to 1:35, from 1:35 to 1:40, from 1:40 to 1:45, from 1:45 to 1:50, from 1:50 to 1:55, from 1:55 to 1:60, from 1:60 to 1:65, from 1:65 to 1:70, from 1:70 to 1:75, from 1:75 to 1:80, from 1:80 to 1:85, from 1:85 to 1:90, from 1:90 to 1:95, from 1:95 to 1:100 or from any combination of one or more of these ranges. The volume of water may be added to the basic zeolite beta suspension in one or more portions to form the dilute basic zeolite beta suspension. In some embodiments, the entire volume of water may be added to the basic zeolite beta suspension in one portion. In other embodiments, the volume of water may be added to the basic zeolite beta suspension in more than one portion. In such embodiments, a first portion the of water may be added to the basic zeolite beta suspension and the suspension may be agitated at a temperature of from 20° C. to 40° C. for a duration of from 1 minute to 12 hours. In one or more embodiments, the suspension may be agitated at a temperature of from 20° C. to 25° C., from 25° C. to 30° C., from 30° C. to 35° C., from 35° C. to 40° C., or from any combination of one or more of these ranges. In one or more embodiments, the suspension may be agitated for from 1 minute to 1 hour, from 1 hour to 2 hours, from 2 hours to 3 hours, from 3 hours to 4 hours, from 4 hours to 5 hours, from 5 hours to 6 hours, from 6 hours to 7 hours, from 7 hours to 8 hours, from 8 hours to 9 hours, from 9 hours to 10 hours, from 10 hours to 11 hours, from 11 hours to 12 hours, or any combination of one or more of these ranges.

After the first portion of water is added to the basic zeolite beta suspension a second portion of the water may be added to form the dilute basic zeolite beta suspension. In one or more embodiments, the dilute basic zeolite beta suspension may be agitated at a temperature of from 20° C. to 40° C. for from 1 minutes to 12 hours. In one or more embodiments, the dilute basic zeolite beta suspension may be agitated at a temperature of from 20° C. to 25° C., from 25° C. to 30° C., from 30° C. to 35° C., from 35° C. to 40° C., or any combination of one or more of these ranges. In one or more embodiments, the dilute basic zeolite beta suspension may be agitated for from 1 minute to 1 hour, from 1 hour to 2 hours, from 2 hours to 3 hours, from 3 hours to 4 hours, from 4 hours to 5 hours, from 5 hours to 6 hours, from 6 hours to 7 hours, from 7 hours to 8 hours, from 8 hours to 9 hours, from 9 hours to 10 hours, from 10 hours to 11 hours, from 11 hours to 12 hours, or any combination of one or more of these ranges.

In one or more embodiments, the dilute basic zeolite beta suspension may be hydrothermally treated. The dilute basic zeolite beta suspension may be hydrothermally treated by heating the suspension to a temperature greater than or equal to 100° C. In one or more embodiments, the dilute basic zeolite beta suspension may be thermally treated in a pressure vessel, such as a hydrothermal autoclave reactor. In one or more embodiments, hydrothermally treating the dilute basic zeolite beta suspension may comprise heating the mixture to a temperature of greater than or equal to 100° C. For example, hydrothermally treating the dilute basic zeolite beta suspension may comprise heating the dilute basic zeolite beta suspension to a temperature of at least 110° C., at least 120° C., at least 130° C., at least 140° C., at least 150° C., at least 160° C., at least 170° C., at least 180° C., at least 190° C., or even at least 200° C. In one or more embodiments, the dilute basic zeolite beta suspension may be heated to a temperature of from 100° C. to 200° C., such as from 100° C. to 110° C., from 110° C. to 120° C., from 120° C. to 130° C., from 130° C. to 140° C., from 140°° C. to 150° C., from 150° C. to 160° C., from 160° C. to 170° C., from 170° C. to 180° C., from 180° C. to 190° C., from 190° C. to 200°° C. or from any combination of one or more of these ranges. Without being bound by theory it is believed that a temperature of less than 100° C. may prevent the dissolution of the parent zeolite beta during hydrothermal treatment.

In one or more embodiments, the dilute basic zeolite beta suspension may be subjected to hydrothermal treatment for a duration of from 1 hours to 120 hours, such as from 1 hour to 5 hours, from 5 hours to 10 hours, from 10 hours to 20 hours, from 20 hours to 30 hours, from 30 hours to 40 hours, from 40 hours to 50 hours, from 50 hours to 60 hours, from 60 hours to 70 hours, from 70 hours to 80 hours, from 80 hours to 90 hours, from 90 hours to 100 hours, from 100 hours to 110 hours, from 110 hours to 120 hours, or from any combination of one or more of these ranges.

In one or more embodiments of the disclosed methods, a solid zeolite beta material may be separated from the hydrothermally treated mixture. In one or more embodiments, the solid zeolite beta material is separated by filtration. In one or more embodiments, the solid zeolite beta material may be washed and dried after being separated from the hydrothermally treated suspension.

In one or more embodiments, the solid zeolite beta material may have a molar ratio of polymorph-A to polymorph-B that is greater than a molar ratio of polymorph-A to polymorph-B of the parent zeolite beta. In embodiments the solid zeolite beta material may have a molar ratio of polymorph-A to polymorph-B greater than or equal to 30% greater than the molar ratio of polymorph-A to polymorph-B of the parent beta zeolite. In one or more embodiments the solid zeolite beta material may consist essentially of polymorph-A and polymorph-B.

In one or more embodiments, the solid zeolite beta material may comprise only one enantiomer of polymorph-A. In one or more embodiments, the solid zeolite beta material may comprise both enantiomers of polymorph-A. In some embodiments, the solid zeolite beta material may comprise equal amounts of both enantiomers. In one or more embodiments, the mole percent of one enantiomer of polymorph-A in the solid zeolite beta material may be higher than the mole percent of polymorph-B in the solid zeolite beta material. In some embodiments, the solid zeolite beta material may be chiral. In such embodiments, the chiral solid zeolite beta material may be utilized to separate chiral components into their respective enantiomers. In some embodiments, the solid zeolite beta material may be contacted with a reactant to catalyze a chemical reaction. In one or more embodiments, the reactant may be a hydrocarbon.

In one or more embodiments, at least a portion of the polymorph-B in the solid zeolite beta material may have an increased unit-cell parameter, such as, for example, an increased d-space when compared to the polymorph-B in the parent zeolite beta.

In one or more embodiments the solid zeolite beta material has a molar ratio of polymorph-A to modified polymorph-B greater than or equal to 30% greater than the molar ratio of polymorph-B of the parent beta zeolite. As used herein the term “modified polymorph-B” refers to a polymorph-B that has a d-spacing as measured using X-ray diffraction of greater than or equal to 1.27 nm. Without being bound by theory it is believed that the larger d-spacing of modified polymorph-B may allow some compositions to pass more freely through modified polymorph-B than through polymorph-B. This may prevent polymorph-B from reacting with some compositions increasing the rate at which polymorph-A interacts with the compositions without removing all of the polymorph-B.

In one or more embodiments the polymorph-B in the solid zeolite beta material may comprise defect-induced mesopores. Defect-induced mesopores are mesopores that are caused solely by defects formed during dissolution. In the absence of an organic template or organic structure-directing agent all mesopores formed would be considered defect-induced mesopores. In one or more embodiments the solid zeolite beta material may comprise multimodal pores. The presence of multimodal pores can be detected using x-ray diffraction analysis as would be known by one of ordinary skill in the art.

In one or more embodiments, the method of making a zeolite beta material may not utilize an organic structure-directing agent. For example, the method may not utilize one or more of tetraethylammonium cation, N,N-dimethyl-2,6-cis-dimethylpiperdinium cation, dimethyldiisopropylammonium cation, N,N,N-trimethylcyclohexanaminium cation, N-ethyl-N,N-dimethylcyclohexanaminium cation, N-isopropyl-N-methyl-pyrrolidinium cation, N-isopentyl-N-methyl-pyrrolidinium cation, and N-isobutyl-N-methyl-pyrrolidinium cation. Without being bound by theory, it is believed that the methods of making a zeolite beta material of the present disclosure that do not utilize an organic structure-directing agent may be less costly than comparable methods of making a zeolite beta material that do utilize an organic structure-directing agent.

### EXAMPLES

The various embodiments of methods described will be further clarified by the following examples. The examples are illustrative in nature, and should not be to limit the subject matter of the present disclosure.

### Example 1

Synthesis of Chiral-Polymorph-A Enriched-Zeolite Beta with High-Silica Parent Zeolite Beat

First 1.0 g of urea was dissolved in 10.0 g of water to from a homogenous solution. To this mixture 1.0 g of dried zeolite CP-811T-150 from Zeolyst with an SiO₂ to Al₂O₃ ratio of 150:1 was added and stirred for 0.5 hours. 20 mL of water was then added to the mixture and the mixture was stirred for 2 hours at room temperature. The resulting mixture was then hydrothermally treated at 130° C. for 72 hours. The obtained solids were then filtered, washed with water, and then dried at 120° C. for 24 hours, and then calcined at 550° C. for 6 h with a heating rate of 1° C./min.

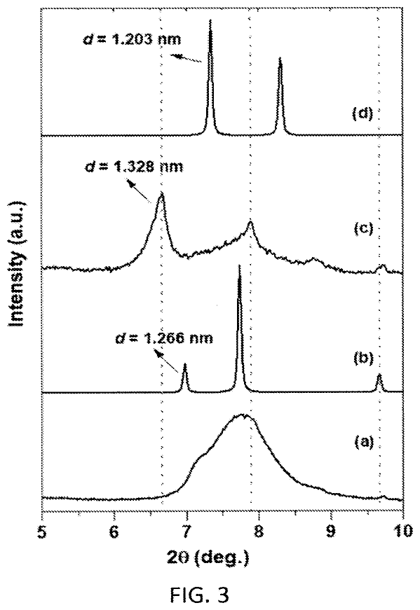

FIG. 3 depicts the X-ray diffraction (XRD) pattern of the prepared zeolite, (c) in comparison with simulated XRD pattern of polymorph-A (b), polymorph-B (d) and parent zeolite, CP-811T-150 (a). For all Examples the XRD measurements were carried out on Bruker D8-Twin X-ray diffractometer with Cu Kα (λ=1.5405 Å) radiation source operating at 40 kV and 40 mA. XRD patterns were recorded from 2theta=5-40° with a scan speed of 0.5 sec/step and step size of 0.02°. The XRD reflections around 2θ of 7.8° and 9.8° are characteristic peaks of polymorph-A framework. In particular, the peak at 9.8° is only observed if the sample has >70% of polymorph-A among the mixture (see FIG. 2). On the other hand, the peak around 6.8° could be attributed to the polymorph-B framework. The shift in the XRD peak to lower angle suggests a partial dissolution of zeolite beta framework. The chirality is induced by selectively changing the pore-size of one of the polymorphs by partial dissolution. As shown in FIG. 3, the prepared zeolite (c) has a shifted peak indicating a change in the d-spacing of the polymorph-B framework present in the prepared zeolite when compared to the simulated polymorph-B (d).

### Example 2

Synthesis of Chiral-Polymorph-A Enriched-Zeolite Beta with Low-Silica Parent Zeolite Beta

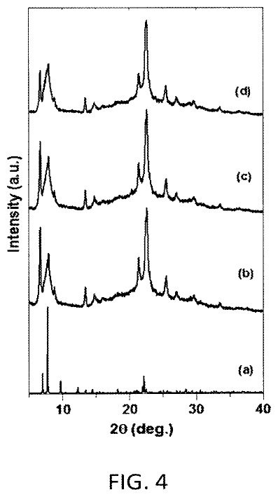

To understand the influence of hydrothermal treatment and the role of SiO₂ to Al₂O₃ ratio of the parent zeolite, the dissolution process was carried out by using CP-811T-100 with an SiO₂ to Al₂O₃ ratio of 100:1, for different periods of time. The dissolution process was similar to the protocol in Example 1 except the hydrothermal treatment was carried out at 150° C. for different periods of time. Samples were treated at 150° C. for 24 h, 48 h and 72 h. The XRD pattern of these zeolites are shown in FIG. 4 as (d) was treated for 24 h, (c) for 48 h, and (b) for 72 h. (d) in FIG. 4 shows high intense peak at 6.8° at the expense of peak around 7.5°. This indicates the dissolution of polymorph-B over time which increases its unit cell parameters and the XRD reflection shifts towards lower angle. In FIG. 4 (a) is a simulated XRD pattern of polymorph-A.

### Example 3

### Synthesis of Chiral-Polymorph-A Enriched-Zeolite Beta Using High-Silica Patent Zeolite Beta and Tetraethylammonium Bromide

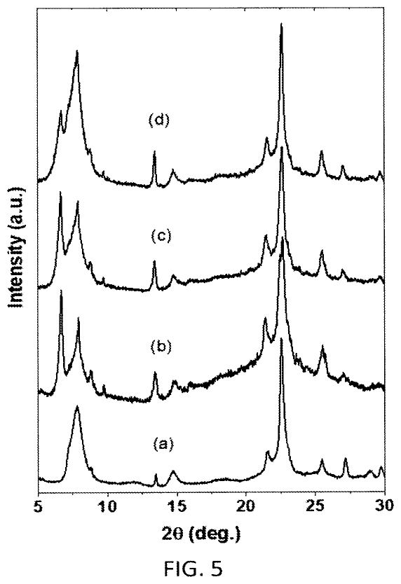

In Example 3, the effect of organic ammonium cations on the dissolution process was examined by adding 0.05 g and 0.1 g of tetraethylammonium bromide (TEABr) to the solution. FIG. 5 depicts the influence of addition of small amounts of tetraethylammonium bromide (TEABr) over the dissolution of zeolite beta, CP-811T-150 with an SiO₂ to Al₂O₃ ratio of 150:1. FIG. 5 (a) and (b) depicts the XRD patterns of the parent zeolite and the zeolite obtained by dissolving at 130° C. for 72 h respectively. The dissolved zeolite has shown considerable amount of amorphous content which can be seen by broad diffraction pattern in the 20 region between 19°-25°. FIG. 5 (c) and (d) depicts the XRD patterns of the zeolites obtained by adding 0.05 g and 0.1 g TEABr to the dissolution process respectively. From the XRD, it is evident that the use of organic ammonium cations decreases the amorphous content in the modified zeolite (c). However, the excess amount of organic ammonium cations can also limit the dissolution process and restrict the chiral enrichment phenomenon (d).

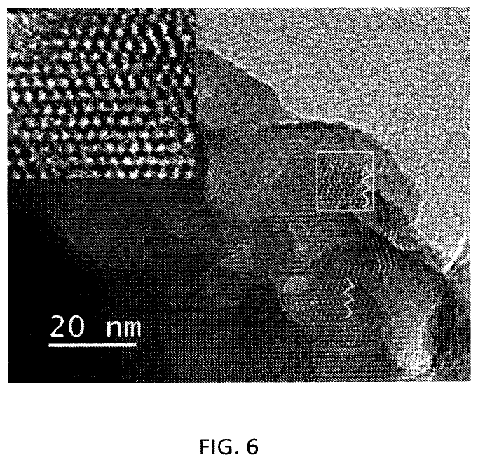

FIG. 6 depicts the TEM image of the zeolite beta material produced from adding 0.05 g of TEABr which shows polymorph-A enriched regions in the zeolite crystal. The zig-zag patterns represent the chiral structure of the polymorph-A pore channels.

The present disclosure includes numerous aspects. A first aspect is a method of making a solid zeolite beta material, the method comprising: adding a parent zeolite beta in a basic solution to form a basic zeolite beta suspension; adding water to the basic zeolite beta suspension to form a dilute basic zeolite beta suspension; hydrothermally treating the dilute basic zeolite beta suspension to form a hydrothermally treated mixture; and separating from the hydrothermally treated mixture a solid zeolite beta material consisting essentially of polymorph-A and polymorph-B, wherein the molar ratio of polymorph-A to polymorph-B of the solid zeolite beta material is greater than molar ratio of polymorph-A to polymorph-B of the parent zeolite beta.

Another aspect is any previous aspect or combination of previous aspects, wherein the method does not utilize an organic structure-directing agent.

Another aspect is any previous aspect or combination of previous aspects, wherein the organic structure-directing agent comprising one or more of tetraethylammonium cation, N,N-dimethyl-2,6-cis-dimethylpiperdinium cation, dimethyldiisopropylammonium cation, N,N,N-trimethylcyclohexanaminium cation, N-ethyl-N,N-dimethylcyclohexanaminium cation, N-isopropyl-N-methyl-pyrrolidinium cation, N-isopentyl-N-methyl-pyrrolidinium cation, and N-isobutyl-N-methyl-pyrrolidinium cation.

Another aspect is any previous aspect or combination of previous aspects, wherein the solid zeolite beta material has a molar ratio of polymorph-A to polymorph-B greater than or equal to 30% greater than the molar ratio of polymorph-A to polymorph-B of the parent beta zeolite.

Another aspect is any previous aspect or combination of previous aspects, wherein the solid zeolite beta material is chiral.

Another aspect is any previous aspect or combination of previous aspects, wherein the parent zeolite beta comprises a *BEA framework comprising polymorph-A and polymorph-B.

Another aspect is any previous aspect or combination of previous aspects, wherein the parent zeolite beta comprises a mole ratio of polymorph-A to polymorph-B of less than or equal to 1.

Another aspect is any previous aspect or combination of previous aspects, wherein the parent zeolite beta comprises a mole ratio of polymorph-A to polymorph-B of greater than 1.

Another aspect is any previous aspect or combination of previous aspects, wherein the parent zeolite beta comprises a silica to alumina mole ratio of from 10:1 to 10,000:1.

Another aspect is any previous aspect or combination of previous aspects, wherein the basic solution comprises urea.

Another aspect is any previous aspect or combination of previous aspects, wherein the basic solution comprises a mass ratio of urea to water of from 1:10 to 1:100.

Another aspect is any previous aspect or combination of previous aspects, wherein the basic zeolite beta suspension comprises a mass ratio of urea to zeolite Beta of from 0.8:1 to 1.2:1.

Another aspect is any previous aspect or combination of previous aspects, wherein adding water to the basic zeolite beta suspension comprises adding a first portion of the water to the basic zeolite beta suspension; agitating the suspension at a temperature of from 20° C. to 40° C. for a duration of from 1 minute to 12 hours; and adding a second portion of the water to the suspension to form the dilute basic zeolite beta suspension.

Another aspect is any previous aspect or combination of previous aspects, further comprising agitating the dilute basic zeolite beta suspension at a temperature of from 20° C. to 40° C. for a duration of from 1 minutes to 12 hours prior to hydrothermal treatment.

Another aspect is any previous aspect or combination of previous aspects, wherein the dilute basic zeolite beta suspension comprises a mass ratio of zeolite beta to water of from 1:15 to 1:60.

Another aspect is any previous aspect or combination of previous aspects, wherein hydrothermally treating the dilute basic zeolite Beta suspension comprises subjecting the dilute basic zeolite Beta suspension to a temperature of from 100° C. to 200° C. for a duration of from 1 hour to 120 hours.

Another aspect is any previous aspect or combination of previous aspects, wherein the solid zeolite beta material is separated from the hydrothermally treated mixture by filtration.

Another aspect is any previous aspect or combination of previous aspects, further comprising washing and drying the solid zeolite beta material.

Another aspect is any previous aspect or combination of previous aspects, wherein the solid zeolite beta material can be contacted with a reactant to catalyze a chemical reaction.

Another aspect is any previous aspect or combination of previous aspects, wherein the solid zeolite beta material can be used to separate the chiral components of a mixture.

Another aspect is any previous aspect or combination of previous aspects, wherein a unit-cell parameter of polymorph B in the solid zeolite beta material is increased.

Another aspect is any previous aspect or combination of previous aspects, wherein the polymorph B in the solid zeolite beta material comprises defect-induced mesopores.

Another aspect is any previous aspect or combination of previous aspects, wherein the solid zeolite beta material comprises multimodal pores.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

What is claimed is:

1. A method of making a solid zeolite beta material, the method comprising:
adding a parent zeolite beta in a basic solution to form a basic zeolite beta suspension;
adding water to the basic zeolite beta suspension to form a dilute basic zeolite beta suspension;
hydrothermally treating the dilute basic zeolite beta suspension to form a hydrothermally treated mixture; and
separating from the hydrothermally treated mixture a solid zeolite beta material consisting essentially of polymorph-A and polymorph-B, wherein a molar ratio of polymorph-A to polymorph-B of the solid zeolite beta material is greater than a molar ratio of polymorph-A to polymorph-B of the parent zeolite beta.

2. The method of claim 1, wherein the method does not utilize an organic structure-directing agent.

3. The method of claim 2, wherein the organic structure-directing agent is one or more of tetraethylammonium cation, N,N-dimethyl-2,6-cis-dimethylpiperdinium cation, dimethyldiisopropylammonium cation, N,N,N-trimethylcyclohexanaminium cation, N-ethyl-N,N-dimethylcyclohexanaminium cation, N-isopropyl-N-methyl-pyrrolidinium cation, N-isopentyl-N-methyl-pyrrolidinium cation, and N-isobutyl-N-methyl-pyrrolidinium cation.

4. The method of claim 1, wherein the solid zeolite beta material has a molar ratio of polymorph-A to modified polymorph-B greater than or equal to 30% greater than the molar ratio of polymorph-A to polymorph-B of the parent beta zeolite.

5. The method of claim 4, wherein the solid zeolite beta material is chiral.

6. The method of claim 1, wherein the parent zeolite beta comprises a *BEA framework comprising polymorph-A and polymorph-B.

7. The method of claim 6, wherein the parent zeolite beta comprises a mole ratio of polymorph-A to polymorph-B of less than or equal to 1.

8. The method of claim 6, wherein the parent zeolite beta comprises a mole ratio of polymorph-A to polymorph-B of greater than 1.

9. The method of claim 1, wherein the parent zeolite beta comprises a silica to alumina mole ratio of from 10:1 to 10,000:1.

10. The method of claim 1, wherein the basic solution comprises urea.

11. The method of claim 10, wherein the basic solution comprises a mass ratio of urea to water of from 1:10 to 1:100.

12. The method of claim 10, wherein the basic zeolite beta suspension comprises a mass ratio of urea to zeolite Beta of from 0.8:1 to 1.2:1.

13. The method of claim 1, wherein adding water to the basic zeolite beta suspension comprises adding a first portion of the water to the basic zeolite beta suspension; agitating the suspension at a temperature of from 20° C. to 40° C. for a duration of from 1 minute to 12 hours; and adding a second portion of the water to the suspension to form the dilute basic zeolite beta suspension.

14. The method of claim 1, further comprising agitating the dilute basic zeolite beta suspension at a temperature of from 20° C. to 40° C. for a duration of from 1 minutes to 12 hours prior to hydrothermal treatment.

15. The method of claim 1, wherein the dilute basic zeolite beta suspension comprises a mass ratio of zeolite beta to water of from 1:15 to 1:60.

16. The method of claim 1, wherein hydrothermally treating the dilute basic zeolite Beta suspension comprises subjecting the dilute basic zeolite Beta suspension to a temperature of from 100° C. to 200° C. for a duration of from 1 hour to 120 hours.

17. The method of claim 1, wherein the solid zeolite beta material is separated from the hydrothermally treated mixture by filtration.

18. The method of claim 1, further comprising washing and drying the solid zeolite beta material.

19. The method of claim 1, wherein the solid zeolite beta material can be contacted with a reactant to catalyze a chemical reaction.

20. The method of claim 1, wherein the solid zeolite beta material can be used to separate the chiral components of a mixture.

21. The method of claim 1, wherein a unit-cell parameter of polymorph B in the solid zeolite beta material is increased.

22. The method of claim 1, wherein the polymorph B in the solid zeolite beta material comprises defect-induced mesopores.

23. The method of claim 1, wherein the solid zeolite beta material comprises multimodal pores.
